(19) United States
(12) Patent Application Publication
(10) Pub. No.: US 2026/0071767 A1
(43) Pub. Date: Mar. 12, 2026

(54) Integrated Solar-Ventilated Panel System for Complete Commercial Roof Replacement

(71) Applicant: George Goksel Bulat, Mooresville, NC (US)

(72) Inventor: George Goksel Bulat, Mooresville, NC (US)

(21) Appl. No.: 19/365,069

(22) Filed: Oct. 21, 2025

(51) Int. Cl. F24F 5/00; E04D 5/12; H02S 20/24; H02S 40/44

(52) U.S. Cl. CPC F24F 5/0075; E04D 5/12; H02S 20/24; H02S 40/44; F24F 2005/0067; F24F 2221/16

(57) ABSTRACT

Integrated Solar-Ventilated Panel System for Complete Commercial Roof Replacement replaces conventional layered roofing with a watertight array of photovoltaic modules and an actively managed air plenum to generate electricity and regulate building thermal loads. The modules form the primary roof surface and may include silicon, Arctic-grade glass-glass, tandem perovskite-silicon, and bifacial variants. Beneath the modules, a plenum cavity communicates with the building interior through a unidirectional airflow membrane. Fans and temperature sensors control airflow through the membrane in cooling and heating modes, exhausting hot air in summer and recirculating solar-heated air in winter. Reflective interior surfaces can increase rear-side irradiance of bifacial modules. The system can be factory-assembled into modular roof units and optionally thermally coupled to electrochemical storage to improve overall energy and HVAC efficiency.

### FIELD OF THE INVENTION

The present invention relates generally to building-integrated photovoltaic systems and, more particularly, to an integrated photovoltaic roof system that uses an actively managed air plenum and unidirectional airflow membrane to provide both on-site electrical generation and dynamic thermal regulation of a building.

### BACKGROUND OF THE INVENTION

Commercial and industrial buildings typically rely on low-slope roofs that are constructed with multiple layers of insulation, vapor barriers, and waterproof membranes. This “layered approach” is designed to meet required thermal resistance d (R-value) and weather protection but generates no revenue and provides no active control of thermal loads. The roof exists purely as a capital expense.

Separately, rooftop photovoltaic systems are commonly installed on top of an existing roof membrane. Conventional installations leave the underlying insulation design unchanged and do not actively manage heat that accumulates at the top of the building or beneath the panels. In many cases, heat buildup under rooftop photovoltaic systems can increase the cooling load of the building and reduce photovoltaic efficiency.

The electrical grid is increasingly stressed by growing electricity demand, driven by data centers, electrification of heating and transportation, and urban growth. At the same time, building owners face higher energy costs and pressure to reduce emissions. There is a need for technologies that simultaneously reduce building energy consumption and provide on-site renewable generation, without duplicating the cost of a conventional roof and a separate photovoltaic system.

There is therefore a need for an integrated photovoltaic roof system that replaces the conventional roof membrane with a watertight photovoltaic surface and that actively manages thermal loads through controlled airflow, reducing HVAC energy use while providing on-site renewable power.

### SUMMARY OF THE INVENTION

In one aspect, an integrated photovoltaic roof system is provided that replaces a conventional low-slope roof assembly with a watertight array of photovoltaic modules forming the primary roof surface, and an actively managed plenum cavity located beneath the modules. The system uses a unidirectional airflow membrane between the plenum and the building interior, together with fans and temperature sensors, to regulate air movement in cooling and heating modes.

In one embodiment, the roof surface comprises a watertight array of photovoltaic modules mechanically secured to an underlying support structure. The array is directly exposed to exterior weather and serves as the only weather-exposed roof layer. Beneath the modules, a plenum cavity of defined depth (for example, between about twelve inches and about twenty-four inches) extends over at least a portion of the building. A unidirectional airflow membrane separates the plenum from the building interior. One or more fans, controlled by an electronic controller using inputs from temperature sensors, are configured to induce airflow through the membrane to regulate the thermal load of the building.

In a cooling mode (summer mode), the system draws hot, stratified air from the building interior through the unidirectional airflow membrane into the plenum and exhausts the heated air to the exterior. This reduces the cooling load on the building's heating, ventilation, and air-conditioning (HVAC) system. In a heating mode (winter mode), the system draws solar-heated air from the plenum and recirculates it into the building interior or into the return side of the HVAC system, thereby supplementing heating and reducing fuel or electric consumption.

In various embodiments, the photovoltaic roof system is compatible with multiple types of photovoltaic modules, including conventional silicon modules, glass-glass “Arctic-grade” modules rated for severe snow and wind loads, tandem perovskite-silicon modules, multi-junction tandem modules, and bifacial variants thereof. The structural and thermal design of the roof assembly is panel-agnostic, such that improved photovoltaic technologies can be adopted without redesigning the plenum, the airflow membrane, or the HVAC interfaces.

In some embodiments, the system further includes a multi-layered waterproofing system independent of the photovoltaic modules, including a continuous monolithic membrane applied to an underlying roof deck and engineered gaskets between module edges to provide long-term water resistance. Acoustic mitigation materials may be applied to undersides of the photovoltaic modules and within the plenum to reduce noise from fan operation and airflow.

In some embodiments, the system is thermally coupled to an electrochemical energy storage subsystem. Heat accumulated in the plenum cavity is transferred to the storage subsystem to maintain the subsystem within an elevated temperature range, for example between about thirty-five degrees Celsius and about fifty degrees Celsius, that enhances electrochemical performance.

The integrated system transforms a conventional roof from a pure expense into a combined energy-generating and energy-saving asset, providing both on-site renewable power and measurable reductions in HVAC energy consumption.

### DRAWINGS DESCRIPTION

### (Submitted as Miscellaneous Incoming Letter)

Application No.: 19/365,069
Inventor: George Goksel Bulat
Title of Invention: Integrated Solar-Ventilated Panel System for Complete Commercial Roof Replacement
Address: 303 Brawley Avenue, Mooresville, NC 28115, USA

All figures are black-and-white line drawings prepared according to USPTO 37 CFR § 1.84 standards.

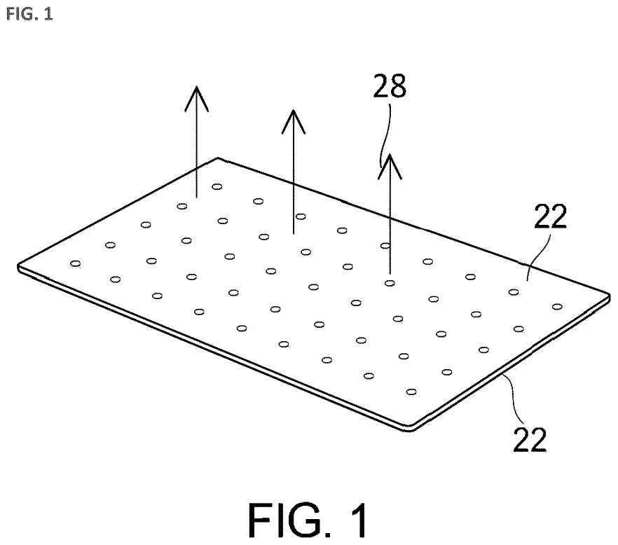

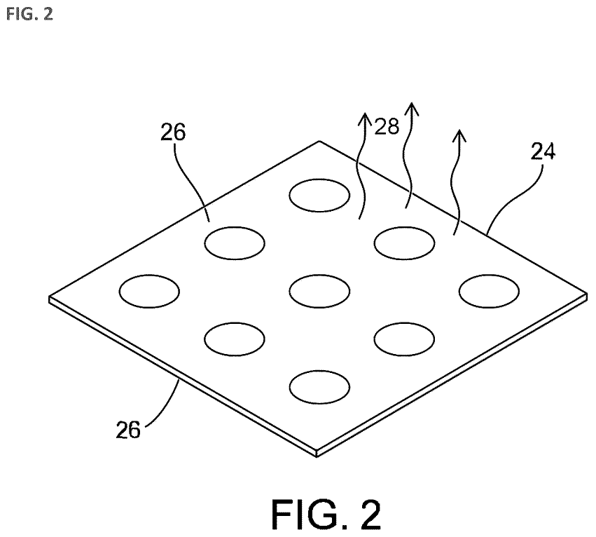

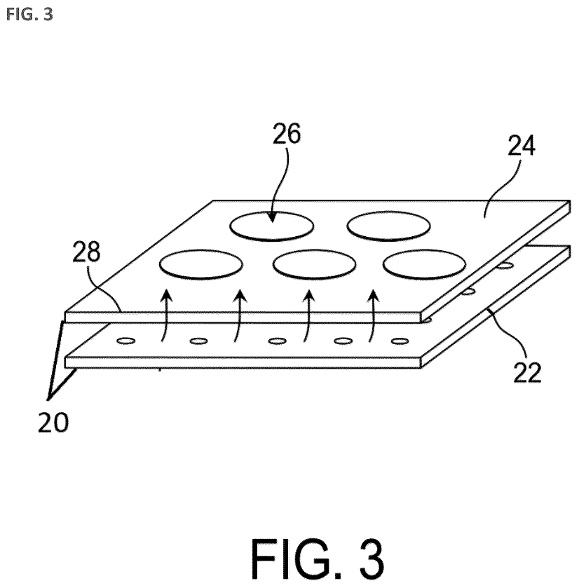

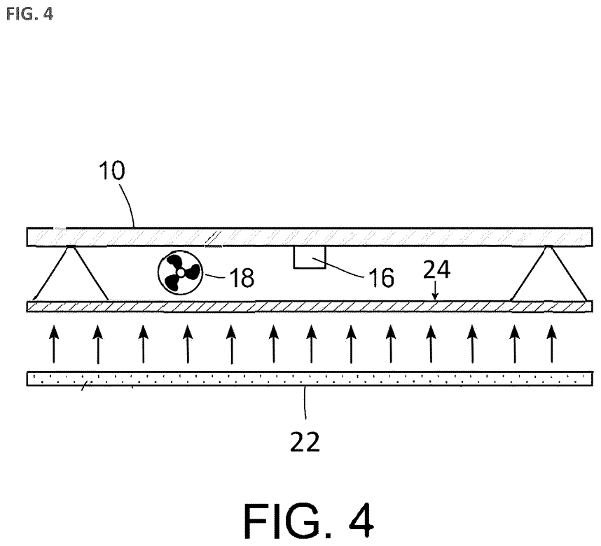

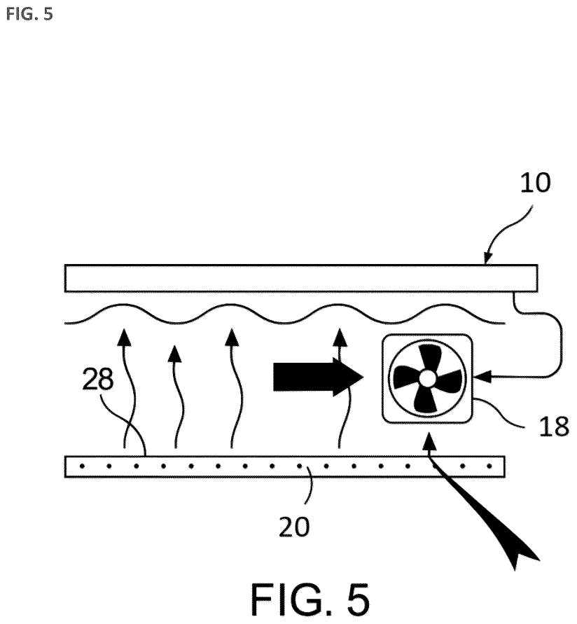

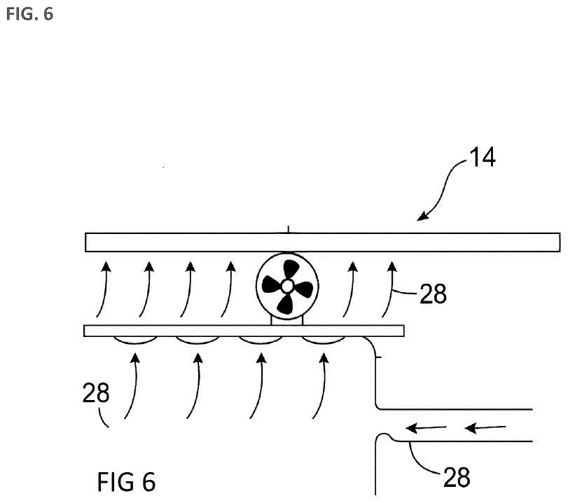

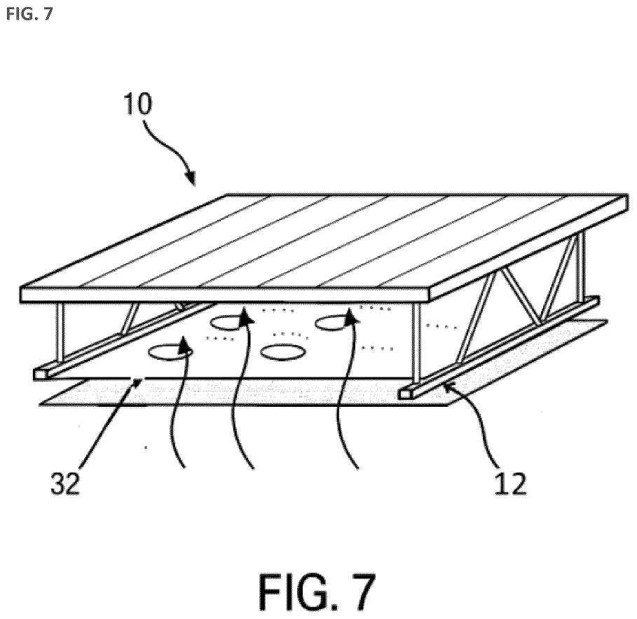

List of Figures

| FIG. # | Description | Purpose / Components Shown |
|---|---|---|
| FIG. 1 | Bottom heavy | Shows holes at the bottom layer (22) |
| | perforated fabric | and upward airflow arrows (28) |
| | layer | |
| FIG. 2 | Top lightweight | Shows top lightweight fabric layer |
| | flap layer | (24) with overlapping circular flaps (26) |
| | | and upward airflow arrows (28) |
| FIG. 3 | Combined | Shows both layers combined (20), |
| | dual-fabric | the bottom perforated layer (22), top |
| | membrane | flap layer (24), flaps (26), and airflow |
| | | arrows (28). Top layer flaps are right |
| | | above bottom layer holes |
| FIG. 4 | Cross-section of | Panels (10), sensors (16), fans (18), |
| | roof assembly | bottom layer (22), top layer (24) |
| FIG. 5 | Hybrid airflow | Panels (10), fans (18), one-directional |
| | schematic | two-layer fabric combination (20), bottom |
| | | passive + fan-assisted airflow (28) |
| FIG. 6 | Warm-air | Passive + fan-assisted airflow (28), |
| | recirculation | panels (10), heat envelope (14), |
| | | fans (18), airflow (28) |
| FIG. 7 | Bifacial panel | Solar panels (10), structural frame (12), |
| | configuration | sunlight reflecting layer (upper fabric |
| | | with flaps) reflecting sunlight toward |
| | | underside of panels (32) |

What is claimed is:

1. An integrated photovoltaic roof system, comprising: a watertight array of photovoltaic modules forming a roof surface; a plenum cavity disposed beneath the roof surface; a unidirectional airflow membrane separating the plenum cavity from an interior space of a building; and one or more fans configured to induce airflow through the unidirectional airflow membrane to regulate a thermal load of the building.

2. The system of claim 1, wherein the photovoltaic modules are selected from the group consisting of silicon photovoltaic modules, glass-glass Arctic-grade silicon photovoltaic modules, tandem perovskite-silicon modules, multi-junction tandem photovoltaic modules, bifacial photovoltaic modules, and combinations thereof.

3. The system of claim 1, wherein the one or more fans are configured to, in a cooling mode, draw heated air from the interior space into the plenum cavity and exhaust the heated air to an exterior of the building, and in a heating mode, draw solar-heated air from the plenum cavity and recirculate the solar-heated air into the interior space or into a heating, ventilation, and air-conditioning system of the building.

4. The system of claim 1, wherein the unidirectional airflow membrane comprises a lower fabric sheet having a plurality of perforations and an upper fabric sheet having a plurality of flexible flaps, each flap overlying a corresponding perforation in the lower fabric sheet.

5. The system of claim 4, wherein each flap has a transverse dimension between about two and about four times a transverse dimension of the corresponding perforation, such that the flap lifts away from the perforation when a pressure differential in a first direction exceeds a threshold value and lies substantially flat to block airflow when the pressure differential is in an opposite direction.

6. The system of claim 2, wherein the photovoltaic modules comprise glass-glass Arctic-grade modules rated to withstand at least about 5,000 Pascals of mechanical loading.

7. The system of claim 2, wherein the photovoltaic modules comprise tandem perovskite-silicon modules having a conversion efficiency of at least about twenty-seven percent.

8. The system of claim 2, wherein the photovoltaic modules comprise bifacial modules and surfaces of the plenum cavity, including an upper surface of the unidirectional airflow membrane, are coated with a high-reflectance finish to increase irradiance incident on a rear side of the photovoltaic modules.

9. The system of claim 1, further comprising an acoustic mitigation package including acoustic damping material applied to undersides of the photovoltaic modules.

10. The system of claim 1, further comprising a multi-layered waterproofing system independent of the photovoltaic modules, the waterproofing system comprising a primary continuous monolithic membrane applied to an underlying roof deck and engineered gaskets applied to joints between adjacent photovoltaic modules.

11. The system of claim 1, wherein a depth of the plenum cavity is between about twelve inches and about twenty-four inches.

12. The system of claim 1, wherein the array of photovoltaic modules is the only layer of the roof that is directly exposed to exterior weather.

13. The system of claim 1, wherein the unidirectional airflow membrane comprises a vapor-permeable membrane providing a continuous air barrier and one or more low-pressure mechanical backdraft dampers integrated into ventilation ductwork, the backdraft dampers having a cracking pressure between about ten Pascals and about twenty Pascals.

14. The system of claim 1, further comprising a plurality of temperature sensors configured to sense temperature within at least one of the plenum cavity and the interior space, and a control system configured to regulate operation of the one or more fans based on the sensed temperature.

15. The system of claim 1, wherein the system is factory-assembled into modular roof units sized for installation over commercial buildings.

16. A method of operating an integrated photovoltaic roof system, comprising: providing a roof assembly comprising a watertight array of photovoltaic modules forming a roof surface, a plenum cavity disposed beneath the roof surface, a unidirectional airflow membrane separating the plenum cavity from an interior space of a building, and one or more fans configured to move air through the unidirectional airflow membrane; sensing a temperature condition within at least one of the plenum cavity and the interior space; and regulating a thermal load of the building by selectively operating the one or more fans based on the sensed temperature condition.

17. The method of claim 16, wherein regulating the thermal load comprises activating exhaust fans to remove heat from the interior space when a cooling condition is met and activating recirculation fans to deliver warm air from the plenum cavity when a heating condition is met.

18. The method of claim 16, further comprising reflecting solar radiation from surfaces within the plenum cavity toward a rear side of bifacial photovoltaic modules to increase electrical energy generation.

19. The method of claim 16, further comprising recording at least one of plenum temperature, fan operating time, and photovoltaic electrical output over a period of operation and using the recorded data to estimate an energy savings and financial performance of the integrated photovoltaic roof system.

20. A photovoltaic roof system, comprising a roof assembly according to claim 1 and an electrochemical energy storage subsystem thermally coupled to the plenum cavity, wherein heat accumulated within the plenum cavity is transferred to the electrochemical energy storage subsystem to maintain the electrochemical energy storage subsystem within a temperature range that enhances electrochemical performance of the electrochemical energy storage subsystem.
